(19) United States
(12) Patent Application Publication
(10) Pub. No.: US 2004/0203658 A1
(43) Pub. Date: Oct. 14, 2004

(54) Method and system for improving radio resource allocation and utilization on a per application and per service basis

(76) Inventor: Raja Narayanan, Plano, TX (US)

Correspondence Address: RG & A, RAFFI GOSTANIAN, JR., 1103 TWIN CREEKS DR., ALLEN, TX, 75013, US

(21) Appl. No.: 10/313,348

(22) Filed: Dec. 6, 2002

(51) Int. Cl. H04M 3/42; H04Q 7/20

(52) U.S. Cl. 455/414.1; 455/450; 455/451; 455/452.1

(57) ABSTRACT

The present invention achieves technical advantages as a method and system for improving radio resource allocation and utilization on a per application and per service basis. In one embodiment, a method for improving radio resource allocation and utilization on a per application basis and on a per service basis comprises receiving information at a network node, wherein the information comprises at least one of a following item from a group consisting of: at least one type of application, at least one type of service, a functional level at which the application or service is executing, at least one type of device supporting the execution, characteristics of the device, and protocols utilized by the application or service. The method further includes determining a radio Quality of Service (QoS) requirement to support the application or the service executing on the device based on at least one of a following item from a group consisting of: the received information, and a user identity, wherein the user is associated with the device, and transmitting a radio resource configuration message based on the determination.

### BACKGROUND

The present invention relates to improving radio resource allocation, and more particularly, to a method and system for improving radio resource allocation and utilization on a per application and per service basis.

Mobile devices are connected to a wireless network via radio links. The bandwidth and quality of these radio links are manipulated at the time of creation and during the time the links are established. These radio resources are requested by the mobile devices in a “fixed” manner and are allocated by a network operator according to predefined business rules and user subscriptions. This method of allocation is static and very coarse in nature. It does not make optimal use of the wireless spectrum, which is a very precious commodity.

Existing solutions attempt to solve the problem by identifying user behavior over time, and provide, at best, a marginal improvement. A limitation of current spectrum utilization is the fact that such utilization is still not as optimal as it could be, however, because the radio resource is not matched to a particular user application or service.

Since user applications and services are diverse in nature, it is desirable to have a varying radio link quality dependant on which applications and services are being run at the time. It is very important for the network operator to adjust and/or reallocate the radio resource dynamically in order to achieve more efficiency and higher quality. Therefore, it is desirable for the present invention to overcome the conventional limitations associated with radio resource allocation.

### SUMMARY

The present invention achieves technical advantages as a method and system for improving radio resource allocation and utilization on a per application and per service basis. In one embodiment, a method for improving radio resource allocation and utilization on a per application basis and on a per service basis comprises receiving information at a network node, wherein the information comprises at least one of a following item from a group consisting of: at least one type of application, at least one type of service, a functional level at which the application or service is executing, at least one type of device supporting the execution, characteristics of the device, and protocols utilized by the application or service. The method further includes determining a radio Quality of Service (QoS) requirement to support the application or the service executing on the device based on at least one of a following item from a group consisting of: the received information, and a user identity, wherein the user is associated with the device, and transmitting a radio resource configuration message based on the determination.

In another embodiment, a method for controlling a radio resource allocation and utilization comprises receiving information at a network node, wherein the information comprises at least one of a following item from a group consisting of: an originating source identifier of an application or service, and a priority for allocating radio resources based on the originating source, determining a radio Quality of Service (QoS) requirement to support the application or the service executing on a device based on the received information and by overriding any previous QoS determination associated with the application or the service associated with the device, and transmitting a radio resource configuration message based on the determination.

In a further embodiment, a system for improving radio resource allocation and utilization on a per application basis and on a per service basis comprises a mobile device, a network node, and a radio resource management node, wherein information from the mobile device is received at the network node, wherein the information comprises at least one of a following item from a group consisting of: at least one type of application, at least one type of service, a functional level at which the application or service is executing, at least one type of the device supporting the execution, characteristics of the device, and protocols utilized by the application or service.

The network node further determines a radio QoS requirement to support the application or the service executing on the device based on at least one of a following item from a group consisting of: the received information, and a user identity, wherein the user is associated with the device, wherein the network node transmits a radio resource configuration message based on the determination to the radio resource management node, wherein the radio resource management node configures radio channels for the mobile device, and wherein the configuration comprises at least one of a following item from a group consisting of: allocating radio channels, de-allocating radio channels, and reconfiguring radio channels.

In yet another embodiment, a network node for improving radio resource allocation and utilization on a per application basis and on a per service basis comprises a processor, wherein information is received at the processor, wherein the information comprises at least one of a following item from a group consisting of: at least one type of application, at least one type of service, a functional level at which the application or service is executing, at least one type of: a device supporting the execution, characteristics of the device, and protocols utilized by the application or service. The processor further determines a radio QoS requirement to support the application or the service executing on the device based on at least one of a following item from a group consisting of: the received information, and a user identity, wherein the user is associated with the device and wherein the processor transmits a radio resource configuration message based on the determination to a radio resource management node.

### BRIEF DESCRIPTION OF THE DRAWINGS

FIG. 1 depicts a diagram of a system architecture according to the present invention;

FIG. 2 depicts a process flow diagram of a method for improving radio resource allocation and utilization on a per application basis and on a per service basis according to the present invention; and

FIG. 3 depicts a process flow diagram of a method for controlling a radio resource allocation and utilization according to the present invention.

### DETAILED DESCRIPTION OF THE INVENTION

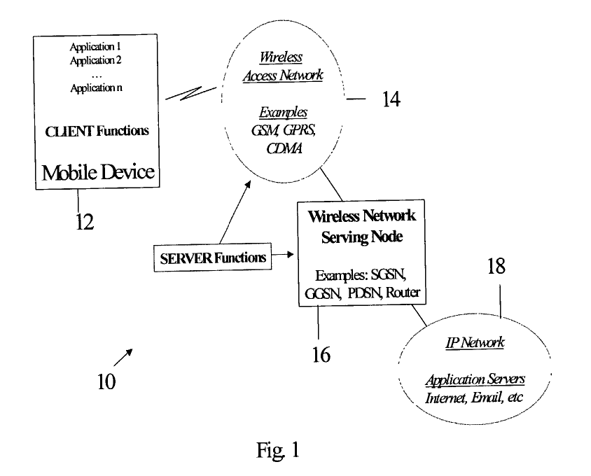

FIG. 1 depicts a system 10 comprising a mobile device 12, a wireless access network 14, a wireless network serving node 16, and an IP network 18. The mobile device 12 can be any type of mobile device that can connect to a wireless network such as a mobile phone, a laptop, a PDA, a software and/or hardware radio, or any similar device. The wireless access network 14 can be a GSM, CDMA, GPRS, or any type of wireless network. The wireless network serving node 16 can be a Gateway GPRS Support Node (GGSN), a Service GPRS Support Node (SGSN), a Packet Data Signaling Node (PDSN), a router, or any similar node. The IP network 18 can be a data network, the Internet, or any similar network, and comprises application servers offering applications such as, for example, email and web browsing.

The present invention can be described in three portions. The first portion is to identify each user application; the second portion is to create the Quality of Service (QOS) requirement for the application or service in the network; and the third portion is to manipulate the QOS of radio links such that a user's requirements are satisfied. The present invention enables a highly superior & intelligent network by taking advantage of information gathered at the device. The solution architecture may be applied to the specifics of any wireless access network, and may be implemented in hardware or software.

The First Portion: Identifying Applications or Services

Identification may occur for any application or service (examples include browsers, media players, databases, games, system applications, commercially available software, telephony applications, push to talk, three way calling, conference calling, basic voice service, etc), and occurs for any type of end user application(s) executing at any functional level (user level, kernel level, etc). Identification may also occur within a minimal time period commensurate to the characteristics of the application in question (but no specific time limits are prescribed) and the methods of the present invention may be implemented on any end user device. Identification may further occur automatically or require user input, and may include any metric pertaining to the application or service (such as, application or service name, port numbers used, memory allocation, protocols used), and any metric as pertaining to the end device (such as device power capability, memory, manufacturer, input types, etc.)

The Second Portion: Create the QOS Requirement for the Application or Service in the Network

Creation of the QOS requirement for the application or service may occur statically (using any form of input) or dynamically in real time (using any form of input), and may also be computed through real-time measurements and/or algorithms that learn about the application or service. The QOS requirement may be stored in any form at any location in the network 10, may include any QOS related parameter (such as minimum, median, maximum throughput, minimum, maximum bit error rate, minimum, maximum latency or delay, etc.), and may be accessible through any standard or non standard interface.

The Third Portion: Manipulation of the QOS Link in a Dynamic Fashion

The QOS parameters that have been created may be used to allocate or reallocate radio resources (such as, for example, dynamically modifying the QOS profile in a GSM network). Manipulation of a QOS link may occur within configurable time limits that a wireless operator may configure (however other time limits or no time limits may be employed) and may be executed in hardware and/or software.

Referring again to FIG. 1, a client/server architecture is presented. The client is an entity on the mobile device 12 that is activated whenever the device is connected to the wireless access network 14; while the server is an entity on the wireless access network 14 and the wireless network serving node 16. The client and the server communicate through a bearer or control channel of existing radio links between the mobile device 12 and the wireless access network 14.

The client executes functions as it pertains to identifying applications or services. The server executes functions as it pertains to creating the QOS requirement for the application or service in the network and manipulating the QOS link in a dynamic fashion. The server may optionally be an external hardware and/or software entity that interfaces with an existing network element (such as a router, the GGSN, the SGSN, and the PDSN) in order to manipulate radio links.

The system 10, which improves radio resource allocation and utilization on a per application basis and on a per service basis, comprises the mobile device 12, the wireless access network 14 (or radio resource management node) and the network node 16. Information from the mobile device 12 is received at the network node 16, wherein the information comprises at least one of a following item from a group consisting of: at least one type of application, at least one type of service, a functional level at which the application or service is executing, at least one type of the device supporting the execution, characteristics of the device, and protocols utilized by the application or service.

The network node 16 determines a radio QoS requirement to support the application or the service executing on the device 12 based on at least one of a following item from a group consisting of: the received information, and a user identity, wherein the user is associated with the device. The network node 16 transmits a radio resource configuration message based on the determination to the radio resource management node 14 which configures radio channels for the mobile device 12. The configuration comprises at least one of a following item from a group consisting of: allocating radio channels, de-allocating radio channels, and reconfiguring radio channels.

The network node 16, which improves radio resource allocation and utilization on a per application basis and on a per service basis, comprises a processor (not shown). Information, which is received at the processor, comprises at least one of a following item from a group consisting of: at least one type of application, at least one type of service, a functional level at which the application or service is executing, at least one type of a device supporting the execution, characteristics of the device, and protocols utilized by the application or service.

The processor determines a radio QoS requirement to support the application or the service executing on the device based on at least one of a following item from a group consisting of: the received information, and a user identity, wherein the user is associated with the device, and wherein the processor transmits a radio resource configuration message based on the determination to a radio resource management node.

A radio resource defined in the radio resource configuration message is used to run the application or the service between the mobile device 12 and the network node 16. The radio resource is either fully matched to a requirement of the application or of the service is dynamically matched to a requirement of the application or of the service, or is statically matched to a requirement of the application or of the service. The radio resource is matched to a requirement of the application or of the service by an operator (not shown).

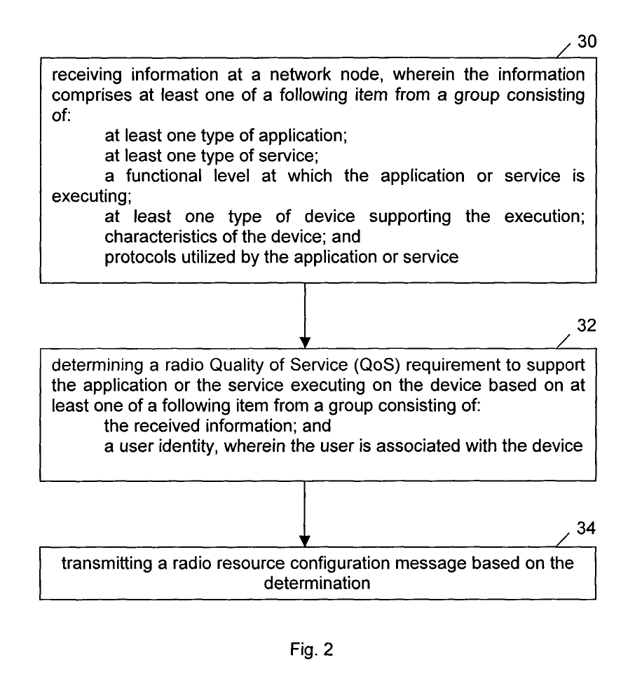

Referring now to FIG. 2, a method for improving radio resource allocation and utilization on a per application basis and on a per service basis is presented. The method begins at step 30 with a receiving of information at a network node, wherein the information comprises at least one of a following item from a group consisting of: at least one type of application, at least one type of service, a functional level at which the application or service is executing, at least one type of device supporting the execution, characteristics of the device, and protocols utilized by the application or service. At step 32, the determining of a radio QoS requirement to support the application or the service executing on the device occurs and is based on at least one of a following item from a group consisting of: the received information, and a user identity, wherein the user is associated with the device. The method continues to step 34 with a transmitting of a radio resource configuration message based on the determination.

The functional level comprises at least one of a following item from a group consisting of: an application mode, and a kernel mode. The characteristics of the device 12 comprises at least one of a following item from a group consisting of: hardware characteristics and capabilities, software characteristics and capabilities, a manufacturer of the device, and inputs to the device. The QoS requirement comprises at least one of a following QoS parameter from a group consisting of: throughput characteristics, error rate characteristics, latency characteristics, and delay characteristics. The radio resource configuration comprises at least one of a following item from a group consisting of: allocating radio channels, de-allocating radio channels, and reconfiguring radio channels.

The storing, by the network node 16, occurs via at least one of a following item from a group consisting of: the QoS requirement, the received information, and the user identity.

In one embodiment, the at least one of the above following item can be accessed by another node (not shown), wherein the other node can transmit the radio resource configuration message based on the at least one of the following item. The other node determines the radio QoS requirement based on the received information at the network node, and transmits the radio resource configuration message based on the determination by the other node.

In another embodiment, a first node can determine the radio QoS requirement based on the received information at the network node 16, and wherein a second node can transmit the radio resource configuration message based on the determination by the first node.

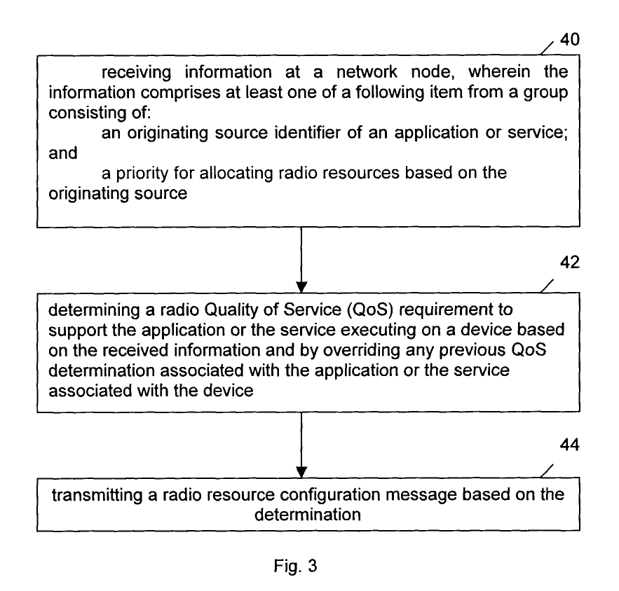

Referring now to FIG. 3, a method for controlling a radio resource allocation and utilization is presented. The method begins at step 40 with a receiving of information at the network node 16, wherein the information comprises at least one of a following item from a group consisting of: an originating source identifier (which may occur automatically or is based on a user input) of an application or service, and a priority for allocating radio resources based on the originating source. A radio QoS requirement to support the application or the service executing on the device 12 is determined based on the received information and by overriding any previous QoS determination associated with the application or the service associated with the device at step 42. At step 44, a radio resource configuration message is transmitted (via a wireless network) based on the determination.

Once the application is identified, the server may then determine the characteristics of application and thus derive the QOS requirement. Meanwhile, the server may carry out adaptive learning processes as flow metrics continue to be collected for all applications. Once the QOS requirement is derived, it may then be used to manipulate the radio links such that radio resources are setup in a dynamic fashion.

If the device roams from a first wireless access network to a second wireless access network (for example, from a CDMA network to a WLAN network), and in a handoff (hard and/or soft) scenario, for example, a server function associated with the second wireless access network can request the information and the determined radio QoS requirement from the first wireless access network (or from a server function associated with the first wireless access network), and can receive the requested information and the requested determined radio QoS requirement. The server function associated with the second wireless access network can transmit a radio resource configuration message based on the received determined radio QoS requirement.

A client/server scenario includes activating client functions when connected to access network, messaging client data to the server using a control or traffic channel, creating, by the server, QOS requirement based on inputs translating, by the server, QOS requirement to radio link parameters depending on a type of access network, and messaging, by the server, the radio access network to allocate/re-allocate radio resources. In an alternate embodiment, other network elements may be messaged by the server to allocate/re-allocate radio resources.

The present invention utilizes radio spectrum very effectively, as required by a user application. Two advantages result. One, better management of spectrum results in greatly improved capacity (the operator can serve more number of users), and two, the response time and throughput characteristics of each application/service is much improved since radio resource allocation is perfectly matched to an application requirement (for example, an email radio link has no errors but is tolerant to delays, streaming media has no delay but more tolerant to a few errors). A wireless operator will have new capabilities to use their radio links as a strategic resource and offer differentiated services (for example, a premium user can utilize premium radio links).

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What is claimed is:

1. A method for improving radio resource allocation and utilization on a per application basis and on a per service basis, comprising:
receiving information at a network node, wherein the information comprises at least one of a following item from a group consisting of:
at least one type of application;
at least one type of service;
a functional level at which the application or service is executing;
at least one type of device supporting the execution;
characteristics of the device; and
protocols utilized by the application or service;
determining a radio Quality of Service (QoS) requirement to support the application or the service executing on the device based on at least one of a following item from a group consisting of:
the received information; and
a user identity, wherein the user is associated with the device; and
transmitting a radio resource configuration message based on the determination.

2. The method of claim 1, wherein the functional level comprises at least one of a following item from a group consisting of:
an application mode; and
a kernel mode.

3. The method of claim 1, wherein the characteristics of the device comprises at least one of a following item from a group consisting of:
hardware characteristics and capabilities;
software characteristics and capabilities;
manufacturer of the device; and
inputs to the device.

4. The method of claim 1, wherein the QoS requirement comprises at least one of a following QoS parameter from a group consisting of:
throughput characteristics;
error rate characteristics;
latency characteristics; and
delay characteristics.

5. The method of claim 1, wherein the radio resource configuration comprises at least one of a following item from a group consisting of:
allocating radio channels;
de-allocating radio channels; and
reconfiguring radio channels.

6. The method of claim 1 further comprising, storing, by the node, at least one of a following item from a group consisting of:
the QoS requirement;
the received information; and
the user identity.

7. The method of claim 6, wherein the at least one of the following item can be accessed by another node.

8. The method of claim 7, wherein the other node can transmit the radio resource configuration message based on the at least one of the following item.

9. The method of claim 1, wherein another node can:
determine the radio QoS requirement based on the received information at the network node; and
transmit the radio resource configuration message based on the determination by the other node.

10. The method of claim 1, wherein a first node can determine the radio QoS requirement based on the received information at the network node, and wherein a second node can transmit the radio resource configuration message based on the determination by the first node.

11. A method for controlling a radio resource allocation and utilization, comprising:
receiving information at a network node, wherein the information comprises at least one of a following item from a group consisting of:
an originating source identifier of an application or service; and
a priority for allocating radio resources based on the originating source;
determining a radio Quality of Service (QoS) requirement to support the application or the service executing on a device based on the received information and by overriding any previous QoS determination associated with the application or the service associated with the device; and
transmitting a radio resource configuration message based on the determination.

12. The method of claim 11, wherein the identifier occurs automatically.

13. The method of claim 11, wherein the identifier is based on a user input.

14. The method of claim 11, wherein the radio resource configuration message is transmitted via a wireless network.

15. The method of claim 11 further comprising, if the device roams from a first wireless access network to a second wireless access network:
requesting, by a server function associated with the second wireless access network, the information and the determined radio QoS requirement from the first wireless access network; and
receiving, by the server function associated with the second wireless access network, the requested information and the requested determined radio QoS requirement.

16. The method of claim 15 further comprising, transmitting, by the server function, a radio resource configuration message based on the received determined radio QoS requirement.

17. A system for improving radio resource allocation and utilization on a per application basis and on a per service basis, comprising:
a mobile device;
a network node; and
a radio resource management node;
wherein information from the mobile device is received at the network node;
wherein the information comprises at least one of a following item from a group consisting of:
at least one type of application;
at least one type of service;
a functional level at which the application or service is executing;
at least one type of the device supporting the execution;
characteristics of the device; and
protocols utilized by the application or service;
wherein the network node determines a radio Quality of Service (QoS) requirement to support the application or the service executing on the device based on at least one of a following item from a group consisting of:
the received information; and
a user identity, wherein the user is associated with the device; and
wherein the network node transmits a radio resource configuration message based on the determination to the radio resource management node;
wherein the radio resource management node configures radio channels for the mobile device; and
wherein the configuration comprises at least one of a following item from a group consisting of:
allocating radio channels;
de-allocating radio channels; and
reconfiguring radio channels.

18. A network node for improving radio resource allocation and utilization on a per application basis and on a per service basis, comprising:
a processor;
wherein information is received at the processor;
wherein the information comprises at least one of a following item from a group consisting of:
at least one type of application;
at least one type of service;
a functional level at which the application or service is executing;
at least one type of a device supporting the execution;
characteristics of the device; and
protocols utilized by the application or service;
wherein the processor determines a radio Quality of Service (QoS) requirement to support the application or the service executing on the device based on at least one of a following item from a group consisting of:
the received information; and
a user identity, wherein the user is associated with the device; and
wherein the processor transmits a radio resource configuration message based on the determination to a radio resource management node.

19. The network node of claim 16, wherein a radio resource defined in the radio resource configuration message is used to run the application or the service between a mobile device and the network node.

20. The network node of claim 17, wherein the radio resource is matched to at least one of a following item from a group consisting of:
fully matched to a requirement of the application or of the service.
dynamically matched to a requirement of the application or of the service; and
matched to a requirement of the application or a requirement of the service by an operator.
